(19) United States
(12) Patent Application Publication
(10) Pub. No.: US 2021/0318082 A1
(43) Pub. Date: Oct. 14, 2021

(54) APPARATUS FOR COOLING LIQUID AND COLLECTION ASSEMBLY THEREFOR

(71) Applicant: Harold D. Curtis Revocable Trust, Oklahoma City, OK (US)

(72) Inventor: Harold D. Curtis, Oklahoma City, OK (US)

(21) Appl. No.: 16/847,316

(22) Filed: Apr. 13, 2020

(51) Int. Cl. F28F 25/04

(52) U.S. Cl. CPC F28F 25/04; F28F 2025/005

(57) ABSTRACT

A liquid collection assembly positionable between a fill material and a fan of a cooling tower for collecting liquid gravitating through the fill material while allowing air to pass up to the fill material. The liquid collection assembly includes that includes a plurality of trough assemblies supported in a spaced apart, vertically overlapping relationship to provide a uniform path for rising air, to capture the down flowing liquid, to provide a barrier between the liquid distribution system and the fan, and to carry the liquid into the at least one gutter. The trough assemblies are supported by a first end plate and a second end plate through which trough assemblies extend.

### BACKGROUND

Conventional types of industrial cooling towers include counterflow towers wherein water or other liquid falls or is sprayed downward in the tower counter to air moving upwardly in the tower. Such systems are used for many applications including water air scrubbers, dust collection equipment, air cooling towers, evaporative coolers, fluid coolers or closed loop cooling towers, evaporative condensers or the like. Typically, such industrial cooling towers are large and permanent installations which include large bottom sumps to collect the falling water.

Some relatively small towers for such purposes have been built which are transportable, for various applications, such as small rooftop towers. For example, U.S. Pat. Nos. 5,227,095 and 5,487,531, issued to Harold D. Curtis, disclose individual modular towers of a size that can be readily transported, prefabricated at a factory, and then easily assembled at a field site to provide the capacity required by the particular water/liquid cooling or treatment project at the site. The systems disclosed in the Curtis patents have a fan or fans for supplying air to the tower in the bottom of the tower below the fill, evaporative cooling media, or liquid cooling coils. The fans force air directly upward in the tower. These systems are referred to generally as direct forced draft counter flow cooling towers.

Each system uses a large water or liquid collection basin, sump or reservoir to collect and contain the circulating water for the system. These basins or sumps are typically large because they must contain enough liquid to charge the system, including all associated piping. Because the process liquid (often, but not always, water) in these systems will scrub the air and collect airborne particles, such particles will settle out in the basins, sumps or reservoirs which then have to be periodically cleaned and the large volume of liquid in the system dumped, cleaned or disposed of. Such basins, sumps and reservoirs become internal sediment basins. Such basins are maintenance intense and require workers to enter and work in a confined space to perform cleaning. Simultaneously the large volume of liquid itself may require water or chemical treatment rather than disposal, further adding to costs. The volume of liquid in such systems greatly increases the weight of the system and increases rooftop loading.

Besides the issues of sedimentation, liquid volume and disposal, proposed tower systems have not adequately addressed the problem of air diffusion by their respective liquid collection systems. Generally, cooling tower (or other forms of towers like fluid coolers) efficiency is determined by how well the up flowing air is mixed with the down coming liquid. The fans in such systems are round and the air is not evenly distributed across the tower media or elements since the fans deliver no balanced air flow. Collection systems generally include a plurality of collection troughs. Sometimes, the troughs have sloping plate member, which overlap with adjacent plate members.

These collection troughs are typically supported in the tower housing by transverse support members or plates which block or limit air dispersion through them and prevent lateral dispersion of air between them. The collection troughs are also closely spaced to reduce water falling past the collection troughs and onto the fans. The close spacing can cause significant pressure drops and thus inefficient air flow. To further reduce water reaching the fans, a damper is sometimes implemented. The damper is a plate positioned between adjacent collection troughs to block water from falling onto the fans when the fans are in an off condition. A problem encountered with dampers is they are positioned at the bottom of the collection troughs and thus susceptible to freezing, which leads to the damper becoming stuck in either the open or closed position.

### SUMMARY OF THE INVENTIVE CONCEPTS

In accordance with an aspect of the inventive concepts low profile, transportable cooling towers and/or fluid coolers/closed loop cooling towers are disclosed which include a liquid collection assembly located above one or more fans in the base of the tower housing. The liquid collection assembly is positioned below the fill media in the tower or heat transfer coils of a fluid cooler. It collects the liquid flowing through the fill or heat transfer coils and directs the same to an internal gutter, from which the liquid may be removed and recirculated.

In accordance with a further aspect of the inventive concepts, a liquid collection assembly is provided that includes a plurality of trough assemblies supported in a spaced apart, vertically overlapping relationship to provide a uniform path for rising air, to capture the down flowing liquid, to provide a barrier between the liquid distribution system and the fan, and to carry the liquid into the at least one gutter.

In one embodiment, the trough assemblies comprise a trough, a liquid diverter plate, and a damper. The trough has a liquid receiving channel, a first side, a second side, a first end, a second end, and upper end, and a lower end. The liquid diverter plate has a first end, a second end, a proximal end, a distal end, an upper surface, and a lower surface. The liquid diverter plate is a separate piece from the trough, and the proximal end of the liquid diverter plate is attached to the second side of the trough with the liquid diverter plate extending upwardly and laterally away from the trough so liquid flowing onto to the upper surface flows into the trough. The distal end is positioned vertically above an adjacent one of the troughs. The damper plate extends from the second side of the trough and is movable between a closed position wherein the damper extends between the second side of the trough and the first side of the adjacent trough to cover the space between the trough and the adjacent trough and an open position wherein the damper is spaced from the adjacent trough.

The liquid collection assembly can be utilized in equipment such as water air scrubbers, dust collection equipment, cooling towers, evaporative coolers, fluid coolers, evaporative condensers and any equipment that utilizes water or any liquid fluid for scrubbing, cleaning, or evaporative cooling. Although the liquid collection assembly is described for use with low profile transportable cooling towers and/or fluid coolers, the liquid collection assembly can be used with any systems, including those having conventional bottom sumps and basins.

Besides collecting the down coming liquid, the liquid collection assembly provides a low-pressure means for the air to flow vertically up between the surface elements of the liquid collection assembly and into the cooling media or fluid cooler coil system. The trough and the liquid diverter plates are strategically configured and spaced to direct and defuse the up flowing air to enhance even airflow through the liquid collection assembly and the fill media or heat exchanger. The structure of the troughs and the liquid diverter plates, and the void of internal support structures, allow air to disperse uniformly. This creates an efficient air to liquid mixture, improving thermal performance of the heat exchanger or cooling tower. In addition, previously proposed liquid collectors have a significant pressure drop across the collector panels. The inventive concepts described herein will reduce the pressure drop as compared to the existing technology. This will further increase thermal performance of the heat exchanger or cooling tower. The liquid collection assembly can be produced much more economically than the present technology.

### BRIEF DESCRIPTION OF THE DRAWINGS

FIG. 1 is a perspective view of a cooling tower module constructed in accordance with the inventive concepts disclosed herein.

FIG. 2 is a perspective view of a liquid collection assembly constructed in accordance with the inventive concepts disclosed herein.

FIGS. 3A-C are perspective views of the liquid collection assembly being installed.

FIG. 4 is a perspective view of a trough assembly of the liquid collection assembly.

FIG. 5 is an end view of the trough assembly of FIG. 4.

FIG. 6 is an end view of a trough.

FIG. 7 is an end view of a liquid diverter plate.

FIG. 8A is sectional view of the liquid collection assembly illustrating a damper plate of the trough assembly in a closed position.

FIG. 8B is sectional view of the liquid collection assembly illustrating the damper plate of the trough assembly in an open position.

FIG. 9 is a perspective view of a first end plate of the liquid collection assembly.

FIG. 10 is a perspective view of a second end plate of the liquid collection assembly.

FIG. 11 is a perspective view of a cross support of the liquid collection assembly.

FIG. 12 is a perspective view of the trough illustrating a plurality of support members attached thereto.

### DETAILED DESCRIPTION OF EXEMPLARY EMBODIMENTS

Before explaining at least one embodiment of the inventive concepts disclosed, it is to be understood that the inventive concepts are not limited in their application to the details of construction and the arrangement of the components or steps or methodologies in this description or illustrated in the drawings. The inventive concepts disclosed are capable of other embodiments or of being practiced or carried out in various ways. Also, it is to be understood that the phraseology and terminology employed is for description only and should not be regarded as limiting the inventive concepts disclosed and claimed herein.

In this detailed description of embodiments of the inventive concepts, numerous specific details are set forth in order to provide a more thorough understanding of the inventive concepts. However, it will be apparent to one of ordinary skill in the art that the inventive concepts within the disclosure may be practiced without these specific details. In other instances, well-known features may not be described to avoid unnecessarily complicating the disclosure.

Further, unless stated to the contrary, “or” refers to an inclusive “or” and not to an exclusive “or.” For example, a condition A or B is satisfied by anyone of: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concepts disclosed. This description should be read to include one or at least one and the singular also includes the plural unless it is obvious that it is meant otherwise.

As used herein any reference to “one embodiment” or “an embodiment” means that a particular element, feature, structure, or characteristic described in the embodiment is included in at least one embodiment. The appearances of the phrase “in one embodiment” in various places in the specification are not necessarily all referring to the same embodiment.

Referring to the drawings, and more particularly to FIG. 1, a cooling tower module 10 constructed in accordance with the inventive concepts disclosed herein is shown. The cooling tower module 10 includes a housing assembly 12, drift eliminators 14, liquid distribution assemblies 16, fill media 18, liquid collection assemblies 20, and fan assemblies 22 for drawing air through the bottom of the housing assembly 12 and blowing it through the liquid collection assemblies 20, the fill media 18, the drift eliminators 14, and out the top of the housing assembly 12 countercurrent to the water distributed from liquid distribution assemblies 16.

Any number of cooling tower modules can be combined to form a cooling tower of desired capacity. In one embodiment, the cooling tower module 10 may be formed to a size of 6 ft. by 12 ft. by 11 ft. Each module can include two sub-modules. The sub-modules may be arranged in a side-by-side relationship and each sub-module may include a drift eliminator 14, a liquid distribution assembly 16, a fill media 18, a liquid collection assembly 20, and a fan assembly 22. The sub-modules may have a size of 6 ft. by 6 ft. by 11 ft. with each sub-module having a cooling capacity of 100 tons.

The housing assembly 12 includes a frame 24 supporting vertical side walls 26 and end walls 28. One of the side walls 26 has been partially cutaway to illustrate the interior of the cooling tower module 10. The frame 24 includes a plurality of lower horizontal beams 30, a plurality of vertical beams 32, and a plurality of upper horizontal beams 34 connected together to form a generally rectangular-shaped support frame. The beams 34 may be fabricated of any suitable material, including metal or pultruded fiberglass. When the cooling tower module 10 is combined with another cooling tower module 10, the adjacent side walls can be omitted so the cooling tower modules 10 openly communicate with one another.

The frame 24 may be supported by four legs (not shown) at the corners of the frame 24. The legs may be telescopically connected to the vertical beams 32.

The housing assembly 12 further includes a liquid collection basin 42. The liquid collection basin 42 is formed to collect water from the liquid collection assembly 20 as described below. The liquid collection basin 42 may include a first gutter 44 extending along an interior side of one of the longitudinal lower horizontal beams 30 and a second gutter (not shown) 6 extending along an interior side of the other longitudinal lower horizontal beam 30. The first gutter 44 and the second gutter may be fluidly connected with a connecting gutter 48. The first gutter 44, the second gutter, and the connecting gutter 48 cooperate to form a first fan receiving space 50 and a second fan receiving space 52. One of the first and the second gutters is provided with a liquid outlet 54. In one embodiment, the liquid outlet 54 has a flange.

In one embodiment, the liquid distribution assembly 16 includes a liquid distribution header 55 and a plurality of lateral feeder conduits. The liquid distribution header and the lateral feeder conduits 56 may be made of any suitable material such as PVC, RFP, copper, stainless steel, aluminum, and resins, for example.

The liquid distribution assembly 16 further has a plurality of nozzle assemblies 66 connected to the lateral feeder conduits 56 and are in fluid communication with the lateral feed conduits 58. The nozzle assemblies 58 function to discharge water therethrough to obtain a uniform distribution of water over the fill media 18. The nozzle assemblies 58 may be any suitable nozzle assemblies. For example, a suitable nozzle assembly is disclosed in U.S. Publication No. 2017/0297043, which is hereby expressly incorporated herein by reference.

The drift eliminators 14 are mounted in the open top of the housing assembly 12 to intercept, trap, and collect mist blown through the housing assembly 12 to prevent the mist from escaping to the atmosphere. Drift eliminators are well known in the art and need not be described.

The fill material 18 may be any suitable fill media. In one embodiment, the fill material may be formed from a plurality of layers. For example, the fill material 18 may be corrugated plastic fill material. Like the drift eliminators, the fill media is well known in the art and need not be described.

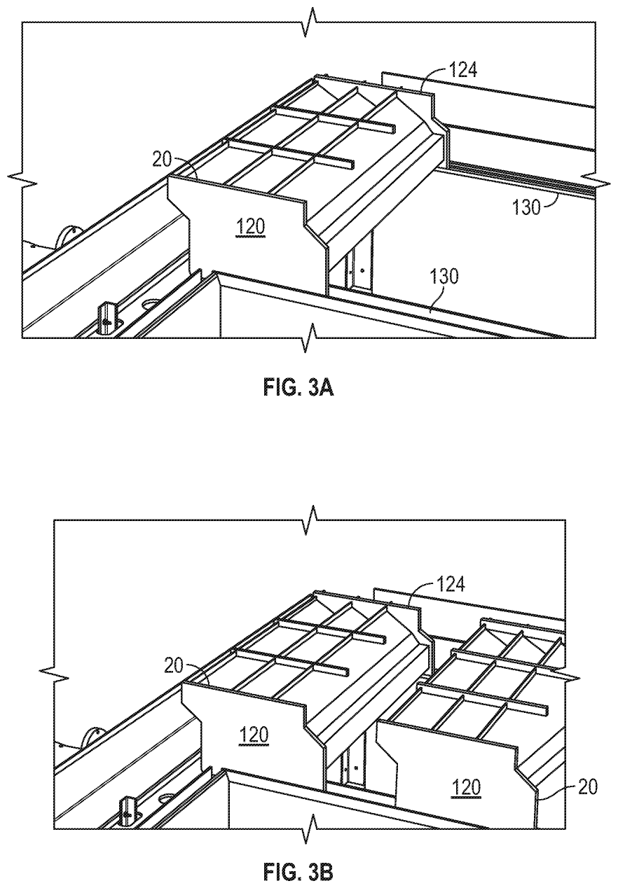

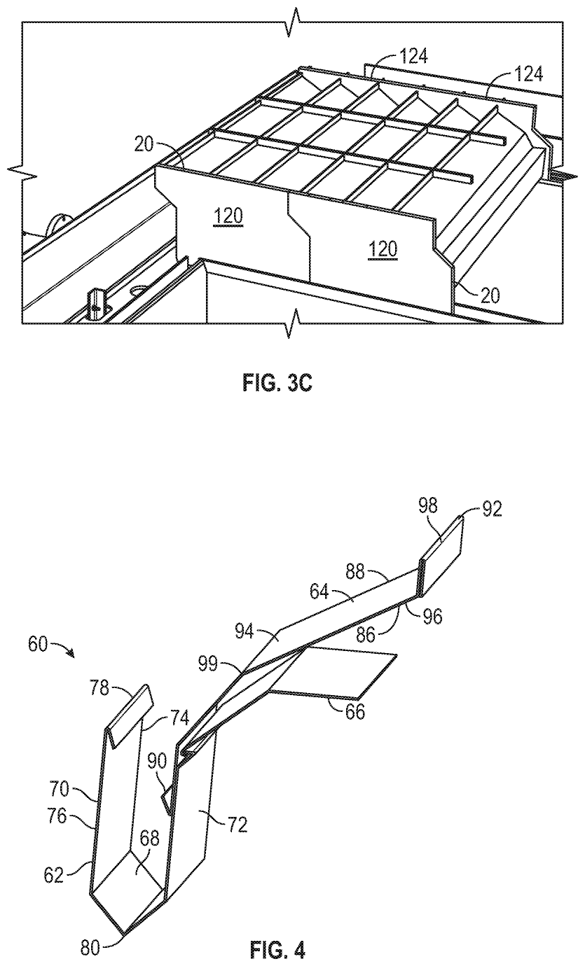

Referring now to FIGS. 1-12 the liquid collection assembly 20 is positioned within the housing assembly 12 below the fill media 18 for collecting liquid that passes from the liquid distribution assembly 16 and through the fill media 18. As illustrated in FIGS. 1 and 3A-3C, the liquid collection assembly 20 may include a plurality of liquid collection assemblies 20 installed and removed in sections. In another version, the liquid collection assembly 20 may be formed as a single unit. Each of the liquid collection assemblies 20 includes a plurality of trough assemblies 60 supported in a spaced apart, vertically overlapping relationship to provide a path or plenum for rising air and to capture the down flowing liquid, to provide a barrier between the liquid distribution system, and the fan, and to carry the liquid into the at least one gutter.

Referring to FIGS. 4-7, the trough assemblies 60 comprise a trough 62, a liquid diverter plate 64, and a damper 66. The trough 62 has a liquid receiving channel 68, a first side 70, a second side 72, a first end 74, a second end 76, and upper end 78, and a lower end 80. The troughs 62 are elongated members that form channels into which liquid falls. The troughs 62 are angled so gravity is utilized to carry the liquid into one of the gutters 44 or 46. While the troughs 62 are shown to have a V-shaped bottom, the troughs 62 may be formed to have other shapes. For example, the bottom of the troughs 62 may be U-shaped.

In one embodiment, the trough 62 is bent along the upper end 78 of the second side 72 to form a hinge chamber 82, which will be described more below. The trough 62 may have a bend 84 along the upper end 78 of the first side 70 to increase structural integrity.

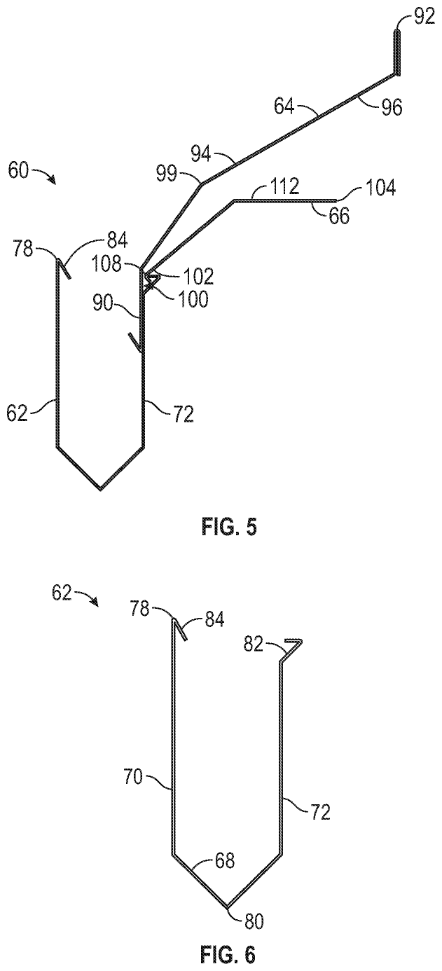

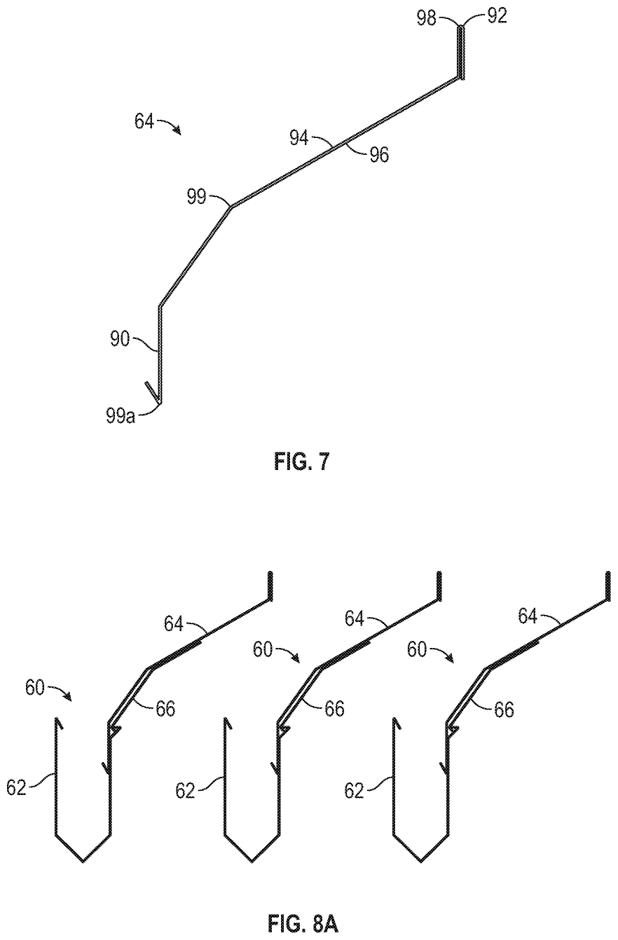

The liquid diverter plate 64 has a first end 86, a second end 88, a proximal end 90, a distal end 92, an upper surface 94, and a lower surface 96. In one embodiment, the liquid diverter plate 64 is a separate piece from the trough 62, and the proximal end 90 of the liquid diverter plate 64 is attached to the second side 72 of the trough 62 with the liquid diverter plate 64 extending upwardly and laterally away from the trough 62 so liquid flowing onto to the upper surface 94 flows into the liquid receiving channel 68 of the trough. It will be appreciated that in another embodiment, the liquid diverter plate 64 can be formed as a single piece with the trough 62. The distal end 92 is positioned vertically above an adjacent one of the troughs 62. The distal end 92 of the liquid diverter plate 64 has an inverted U-shape bend 98 to provide structural rigidity and to cause liquid dripping from the liquid diverter plate 64 to drop rather than travel along the lower surface 96 of the liquid diverter plate 64. An intermediate portion of the liquid diverter plate 64 has a bend 99. The proximal end 90 of the liquid diverter plate 64 is configured to be attached to the second side 72 of the trough 62 with suitable fasteners or adhesive, and the proximal end 90 of the liquid diverter plate 64 may have a bend 99a (FIG. 7) to increase structural integrity. The liquid diverter plate 64 cooperates with the trough 62 to further define a hinge trough 100 (FIG. 5) extending the length of the trough assembly 60.

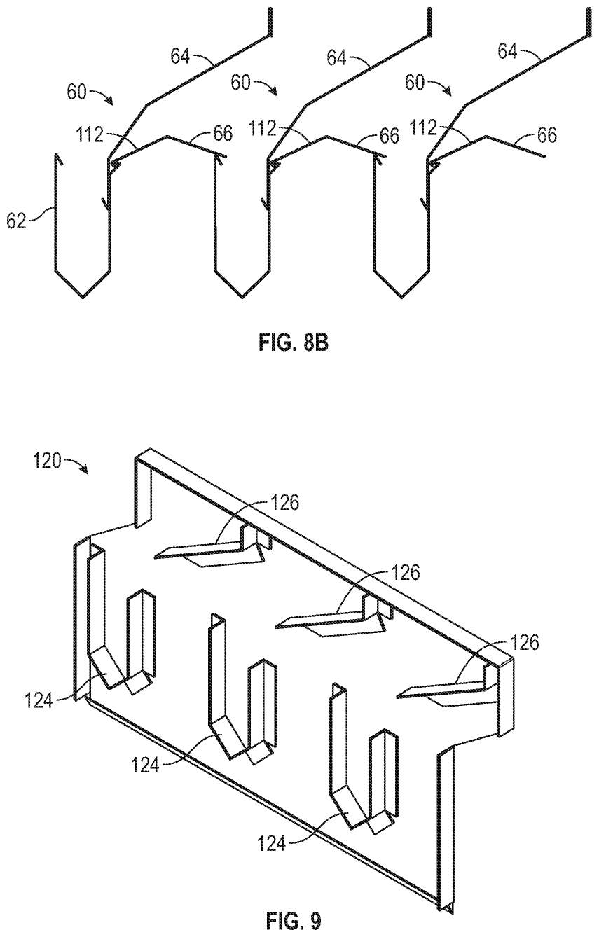

The damper plate 66 extends from the second side 72 of the trough 62 and is movable between a closed position (FIG. 8A) wherein the damper plate 66 extends between the second side 72 of the trough 62 and the first side 70 of the adjacent trough 62 to cover the space between the trough 62 and the adjacent trough 62 and an open position (FIG. 8B) wherein the damper plate 66 is spaced from the adjacent trough 62.

The damper plate 66 extends from the upper end 78 of the trough 62. The damper plate 66 has a proximal end 102 and a distal end 104. In one embodiment, the proximal end 102 is hinged to the second side 72 of the trough 62. By way of example, the proximal end 102 has a bend forming a hinge member 108 positioned in the hinge chamber 82. The hinge member 108 is insertable into the hinge chamber 82 and configured to hook in the hinge chamber 82.

The damper plate 66 has a longitudinal bend 110 so the damper plate 66 has an inverted V shape that conforms to the contour of the liquid diverter plate 64 when the damper plate 66 is in the open position. In the closed position, the inverted V shape allows a portion of liquid falling onto an upper side 112 of the damper plate 66 to flow into the adjacent trough 62 and another portion of liquid falling onto the upper side 112 of the damper plate 66 to flow into the hinge trough 100, which is in fluid communication with the gutter 44. The inverted V shape further reduces the radius of travel of the damper plate 66 between the closed position and the open position.

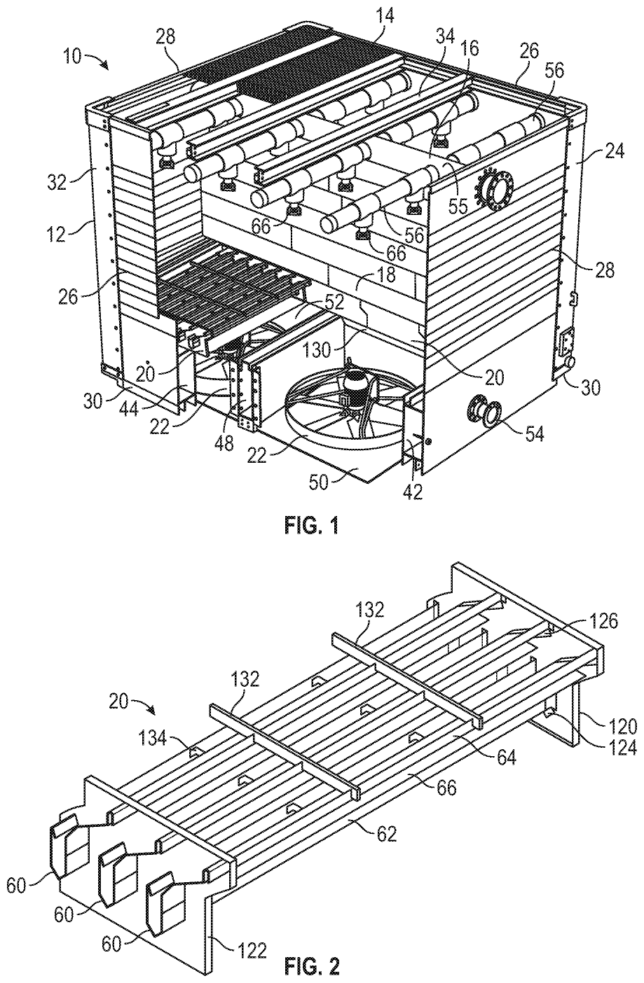

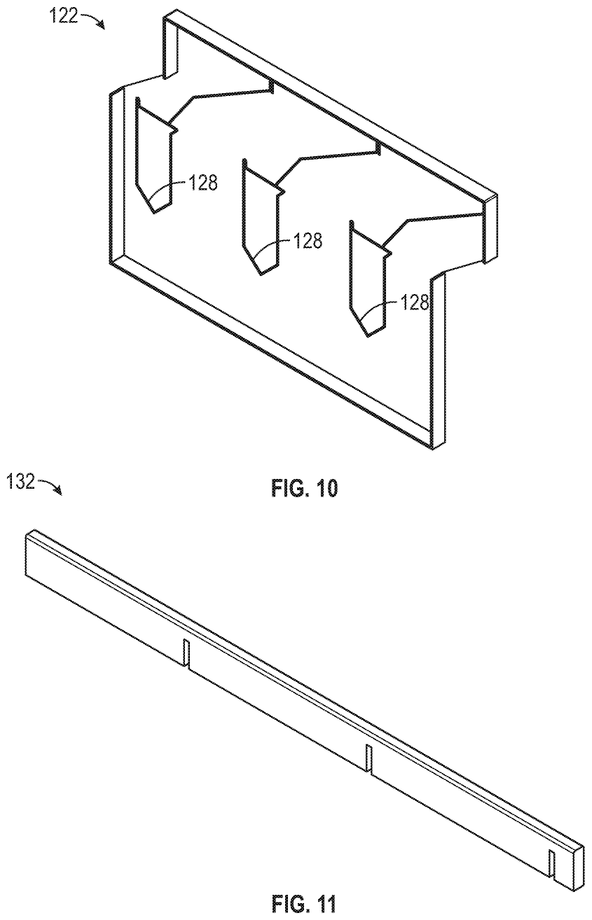

The liquid collection assembly 20 further has a first end plate 120 (FIGS. 2 and 9) attached to the first end 74 of the trough 62 and the first end 86 of the liquid diverter plate 64; and a second end plate 122 (FIGS. 2 and 10) through which the second end 76 of the trough 62 and the second end 88 of the liquid diverter plate 64 extend. The first end plate 120 is provided with a series of trough brackets 124 and liquid diverter plate brackets 126. The first end 74 of the troughs 62 are supported by the trough brackets 124 and the first end 86 of the liquid diverter plates 64 are supported by the liquid diverter plate brackets 126. The first end 74 of the troughs 62 and the first end 86 of the liquid diverter plates 64 are fluidically sealed relative to the first end plate 120 with a suitable sealant and may be secured to the trough brackets and the liquid divertor plate brackets 126 with fasteners, such as rivets.

The second end plate 122 has a plurality of openings 128 corresponding to the profile of the liquid receiving channels of the troughs and the liquid diverter plates 64. The troughs 62 and the liquid diverter plates 64 are secured to the second end plate 122 with suitable fasteners and/or fluid sealant or adhesive so liquid flowing along the liquid receiving channels 68 and the hinge trough 100 passes through the second end plate 122 and into the gutter 44.

The liquid collection assembly 20 is supported by the structure forming the first gutter 44 and the second gutter. As shown in FIGS. 3A-3C, the liquid collection basin 42 may be provided with parallel tracks 130 for slidingly supporting the liquid collection assembly 20.

With further reference to FIGS. 3A-3C, the edges of the end walls 120 and 122 may be configured to mate with an end wall of an adjacent liquid collection assembly when abutted with one another to form a fluid tight seal. In one embodiment, opposing edges of the end walls 120 and 122 may be provided with a tongue and groove structure (not shown) to permit adjacent sections to mate with one another.

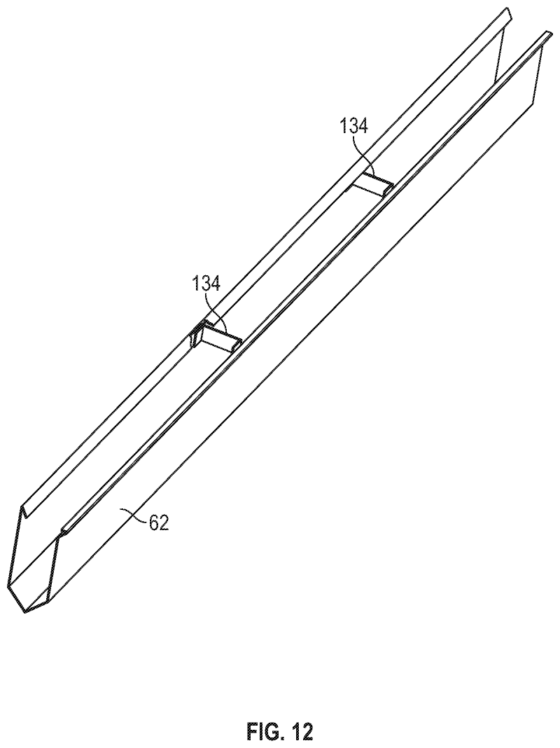

Desirably, the trough assemblies 60 require no intermediate supports, which would interfere with the flow of air and liquid through the cooling tower module. Nevertheless, supports may be used. By way of example, the supports may be in the form of cross supports 132 (FIG. 11), and spacers 134 (FIG. 12). The cross supports 132 are spaced apart from one another and engage to the distal ends 92 of each of the liquid diverter plates 64 so as not to be positioned in the air path. The spacers 134 are U-shaped members positioned vertically in the troughs 62, and thus not in the air path, to provided support for the troughs 62, as needed.

The liquid collection assembly 20 defines a vertical flow passage with the trough assemblies 60 supported within the flow passage to allow air to pass from the fan assembly 22 and through the flow passage and to collect liquid falling into the flow passage and to direct the collected water to the gutter 44.

The trough 62, the liquid diverter plate 64, the damper plate 66, first and second end plates 120 and 122, the cross supports 132, and the spacers 134 may be fabricated of a metal or sufficiently rigid plastic or fiberglass material.

FIGS. 8A and 8B are schematic illustrations of the array of the trough assemblies 66. The air flowing from the fan assembly 22 encounters the lower end of the troughs 62 and passes through the gaps or plenums between the troughs 62 and the liquid diverter plates 64. In addition, the air flowing from the fan assembly 22 causes the damper plates 66 to move to the open position.

One of the advantageous of the inventive concepts disclosed herein is the increase and uniformity of the gaps between the trough assemblies 60 relative to the volume of the troughs 62. This enhances more efficient air to liquid mixtures which increases performance of the system. In addition, the uniformity of the gaps reduces the pressure drop from the lower end to the upper end of the liquid collection assembly 20. The reduced pressure drop also increases thermal performance of the cooling tower. An additional advantage is that there is a lower pressure drop because of the void of support structures in the gaps thus increasing the length of the flow space between adjacent ones of the trough assemblies 60. In one embedment of the liquid collection assembly 20, the effective width opening between adjacent trough assemblies 66 may be approximately four inches.

In one embodiment, the troughs 62 have a width of about 2.5 inches and spaced from the adjacent trough 62 about 8 inches. This provides a gap of about 5.5 inches between each trough 62. In one embodiment, the liquid diverter plates 64 are configured to have a spacing of about 4.25 inches between each adjacent liquid diverter plate 64 and the upper end 78 of the adjacent trough 62.

While the trough assemblies 60 are illustrated as being uniformly laterally spaced from one another, uniform spacing of the trough assemblies 60 is not mandatory. Depending upon the application or the specific shape of the housing, it is within the scope of the inventive concepts to vary the spacing between the trough assemblies 60 to direct air flow to specific areas. In addition, varying the size of the openings between adjacent surfaces will affect the air velocity between the adjacent surfaces. By varying the gap between them, air distribution may be better balanced throughout the system. However, the trough assemblies 60 should remain overlapped, so liquid cannot escape to the fans.

Although the inventive concepts have been illustrated and described in connection with compact, transportable cooling towers, the inventive concepts disclosed herein are equally adapted to use in fluid coolers. In fluid coolers liquid is passed countercurrent across a coil (i.e., heat exchanger) carrying a liquid to be cooled. Also, although the liquid collection assembly 20 has been illustrated and described in connection with compact, transportable cooling towers with bottom fan assemblies, the liquid collection assembly 20 may be used in more conventional systems having conventional liquid sumps or basins below the liquid cooler or fill media.

The inventive concepts disclosed provide several major improvements. The liquid collection assembly 20 collects the down coming liquid, but also directs and diffuses the up flowing air so that all the fill media gets substantially equal air flow across the entire surface of the heat exchanger or fill media. This enhances more efficient air to liquid mixtures which increases performance of the system. In addition, the design of the liquid collection assemblies reduces the pressure drop across the surface elements, as compared to existing technology. The reduced pressure drop also increases thermal performance of the cooling tower. The liquid collection assembly 20 is relatively simple and economical to manufacture.

From the above description, it is clear that the inventive concepts disclosed herein are well adapted to carry out the objects and to attain the advantages mentioned herein, as well as those inherent in the invention. While exemplary embodiments of the inventive concepts have been described for purposes of this disclosure, it will be understood that numerous changes may be made which will readily suggest themselves to those skilled in the art and which are accomplished within the spirit of the inventive concepts disclosed.

What is claimed is:

1. A liquid collection assembly positionable between a fill material and a fan of a cooling tower for collecting liquid gravitating through the fill material while allowing air to pass up to the fill material, the liquid collection assembly comprising:
a plurality of trough assemblies supported in a spaced apart, vertically overlapping relationship to define a plenum between adjacent trough assemblies and to capture the down flowing liquid, to provide a barrier between the liquid distribution system and the fan, and to carry the liquid into the at least one gutter, the trough assemblies comprising:
a trough having a liquid receiving channel, a first side, a second side, a first end, a second end, and upper end, and a lower end; and
a liquid diverter plate having a first end, a second end, a proximal end, a distal end, an upper surface, and a lower surface, the liquid diverter plate extending upwardly and laterally away from the trough so liquid flowing onto to the upper surface flows into the trough, the distal end of the liquid diverter plate positioned vertically above an adjacent one of the trough assemblies;
a first end plate attached to the first end of the trough and the first end of the liquid diverter plate; and
a second end plate through which the second end of the trough and the second end of the liquid diverter plate extend, the second end plate having a plurality of openings corresponding to the liquid receiving channels of the troughs.

2. The assembly of claim 1, wherein the liquid collection assembly is void of any support structure extending between adjacent trough assemblies from the first end plate to the second end plate and from the lower end of the troughs to the distal end of the liquid diverter plates to allow air to disperse across an entirety of the plenum.

3. The assembly of claim 1, wherein the trough assemblies further comprise a damper plate extending from the second side of the trough and movable between a closed position wherein the damper extends between the second side of the trough and the first side of the adjacent trough to cover the space between the trough and the adjacent trough and an open position wherein the damper is spaced from the adjacent trough.

4. The assembly of claim 3, wherein the damper plate extends from the upper end of the trough.

5. The assembly of claim 4, wherein the damper plate has an inverted V-shape.

6. The assembly of claims 5, wherein the damper plate substantially conforms to the contour of the liquid diverter plate when the damper plate is in the open position.

7. The assembly of claim 5, wherein the damper plate is hinged to the trough, wherein the liquid diverter plate is a separate piece relative to the trough with the proximal end of the liquid diverter plate attached to the second side of the trough to cooperate with the trough to form a hinge trough so liquid flowing on one side of the inverted V-shaped damper plate flows into the hinge trough, and wherein the hinge trough extends past the second end plate.

8. The assembly of claim 1, wherein the distal end of the liquid diverter plate has an inverted U-shape.

9. The assembly of claim 1, wherein the first end of the trough and the first end of the liquid diverter plate are fluidically sealed relative to the first end plate.

10. The assembly of claim 2, wherein the liquid collection assembly further comprises a plurality of cross supports spaced apart from one another and attached to the distal ends of each of the liquid diverter plates.

11. An apparatus, comprising:
a housing having at least one gutter;
a body of fill material disposed in the housing;
a liquid distribution system disposed in the housing and positioned above the fill material for distributing liquid on top of the fill material so the liquid gravitates downward through the fill material;
a fan positioned below the body of fill material for blowing air upward through the fill material; and
a liquid collection assembly positioned between the fill material and the fan for collecting the liquid gravitating through the fill material while allowing air to pass up to the fill material, the liquid collection assembly comprising:
a plurality of trough assemblies supported in a spaced apart, vertically overlapping relationship to define a plenum between adjacent trough assemblies and to capture the down flowing liquid, to provide a barrier between the liquid distribution system and the fan, and to carry the liquid into the at least one gutter, wherein the trough assemblies comprise:
a trough having a liquid receiving channel, a first side, a second side, a first end, a second end, and upper end, and a lower end; and
a liquid diverter plate having a first end, a second end, a proximal end, a distal end, an upper surface, and a lower surface, the liquid diverter plate extending upwardly and laterally away from the trough so liquid flowing onto to the upper surface flows into the trough, the distal end of the liquid diverter plate positioned vertically above an adjacent one of the trough assemblies; and
a first end plate attached to the first end of the trough and the first end of the liquid diverter plate; and
a second end plate through which the second end of the trough and the second end of the liquid diverter plate extend, the second end plate having a plurality of openings corresponding to the liquid receiving channels of the troughs.

12. The apparatus of claim 11, wherein the liquid collection assembly is void of any support structure extending between adjacent trough assemblies from the first end plate to the second end plate and from the lower end of the troughs to the distal end of the liquid diverter plates to allow air to disperse across an entirety of the plenum.

13. The apparatus of claim 11, wherein the trough assemblies further comprise a damper plate extending from the second side of the trough and movable between a closed position wherein the damper extends between the second side of the trough and the first side of the adjacent trough to cover the space between the trough and the adjacent trough and an open position wherein the damper is spaced from the adjacent trough.

14. The apparatus of claim 13, wherein the damper plate extends from the upper end of the trough.

15. The apparatus of claim 14, wherein the damper plate has an inverted V-shape.

16. The apparatus of claims 15, wherein the damper plate conforms to the contour of the liquid diverter plate when the damper plate is in the open position.

17. The apparatus of claim 15, wherein the damper plate is hinged to the trough, wherein the liquid diverter plate is a separate piece relative to the trough with the proximal end of the liquid diverter plate attached to the second side of the trough to cooperate with the trough to form a hinge trough so liquid flowing on one side of the inverted V-shaped damper plate flows into the hinge trough, and wherein the hinge trough extends past the second end plate.

18. The apparatus of claim 11, wherein the distal end of the liquid diverter plate has an inverted U-shape.

19. The apparatus of claim 11, wherein the first end of the trough and the first end of the liquid diverter plate are fluidically sealed relative to the first end plate.

20. The apparatus of claim 12, wherein the liquid collection assembly further comprises a plurality of cross supports spaced apart from one another and attached to the distal ends of each of the liquid diverter plates.
